(19) United States
(12) Patent Application Publication
(10) Pub. No.: US 2007/0200659 A1
(43) Pub. Date: Aug. 30, 2007

(54) REMOTE-CONTROLLABLE TIME-BASED POWER CONTROL APPARATUS

(76) Inventor: Young-Soo Kim, Gyeonggido (KR)

Correspondence Address: LADAS & PARRY, 26 WEST 61ST STREET, NEW YORK, NY, 10023, US

(21) Appl. No.: 10/578,240

(22) PCT Filed: Dec. 22, 2003
(86) PCT No.: PCT/KR03/02796

§ 371 Date: Jan. 17, 2007

(30) Foreign Application Priority Data
Nov. 17, 2003 (KR) 10-2003-0081074

(51) Int. Cl. G05B 23/02

(52) U.S. Cl. 340/3.71; 340/825.22; 340/825.69; 323/324

(57) ABSTRACT

The present invention relates to a remote-controllable time-based power control apparatus, which includes a remote controller, which is capable of setting the operating time of a power plug and has a display unit for displaying the remaining operating time and ON/OFF statuses, and a control means for turning on the power plug for the preset operating time received from the remote controller while communicating with the remote controller in a wireless manner and turning off the power plug to automatically turn off an electronic appliance when time counted by the control means reaches the preset operating time, thus enabling parents to remotely control the operating times of computers, video game machines, televisions, etc. enjoyed by their children. The power control apparatus of the present invention includes a remote controller (1), a power plug (2), and a control means (3).

### TECHNICAL FIELD

The present invention relates, in general, to a remote-controllable time-based power control apparatus and, more particularly, to a remote-controllable time-based control apparatus, which enables parents to remotely control the operating times of computers, video game machines, televisions, etc. enjoyed by their children.

### BACKGROUND ART

Recently, as a large number of juveniles spend a great deal of enjoying computer games, video game machines, televisions, etc., a problem in that they relatively neglect studies has been generated.

That is, because conventional electronic appliances are turned on/off by power switches provided thereon, parents of children cannot frequently and suitably control the time children spend using computers, video game machines, televisions, etc., so that the studies of the children become neglected.

Moreover, as dual-income families have increased while the family trend is toward the nuclear family, a child frequently spends a lot of time at home alone, so that child's parents cannot control the time spent using a computer, a video game machine, a television, etc., and it is difficult for the parents to personally monitor their child enjoying the computer or video game machine in child's room even when the parents are in the home.

### DISCLOSURE OF THE INVENTION

Accordingly, the present invention has been made keeping in mind the above problems occurring in the prior art, and an object of the present invention is to provide a remote-controllable time-based power control apparatus, which includes a remote controller, which is capable of setting the operating time of a power plug and has a display unit for displaying the remaining operating time and ON/OFF statuses, and a control means for turning on the power plug for the preset operating time received from the remote controller while communicating with the remote controller in a wireless manner and turning off the power plug to automatically turn off an electronic appliance when time counted by the control means reaches the preset operating time, thus enabling parents to remotely control the operating times of computers, video game machines, televisions, etc. enjoyed by their children.

### BRIEF DESCRIPTION OF THE DRAWINGS

FIG. 1 is a view showing a remote-controllable time-based power control apparatus according to the present invention;

FIG. 2 is a block diagram showing the construction of a remote controller applied to the present invention; and

FIG. 3 is a block diagram showing the construction of a control means applied to the present invention.

### BEST MODE FOR CARRYING OUT THE INVENTION

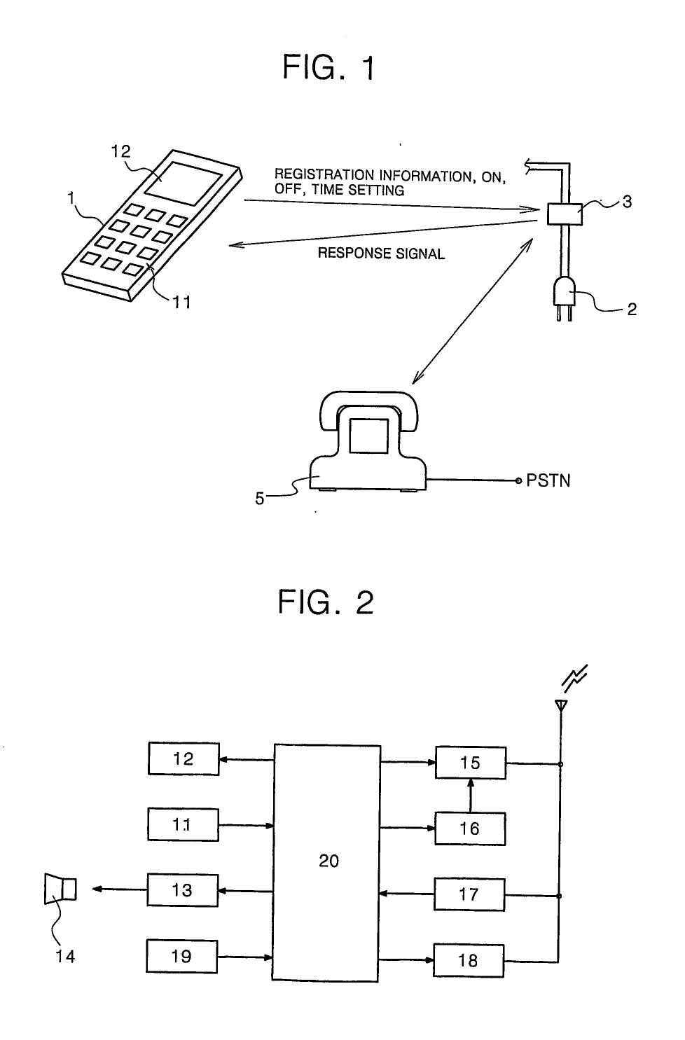

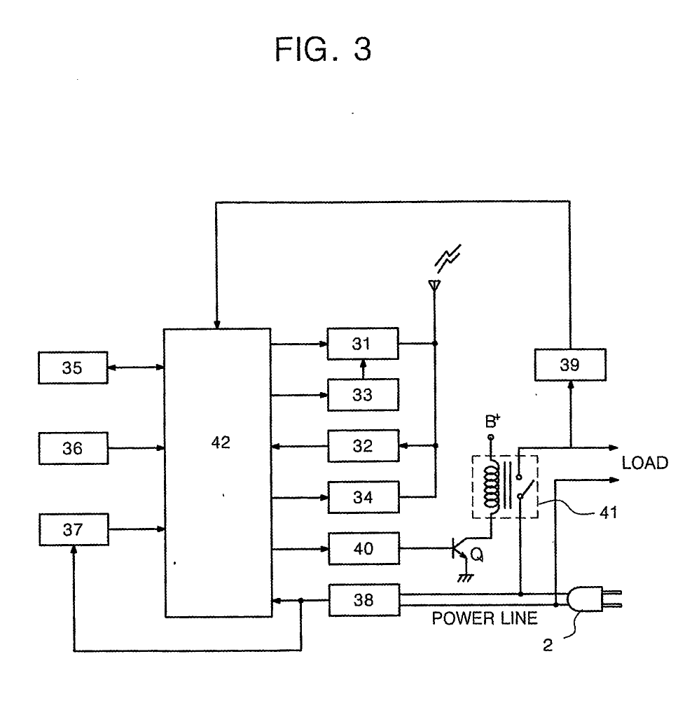

FIGS. 1 to 3 are views showing a remote-controllable time-based power control apparatus according to the present invention to accomplish the above object. A preferred embodiment of the present invention is described with reference to FIGS. 1 to 3.

To achieve the object of the present invention, the power control apparatus of the present invention includes a remote controller 1 comprised of a key unit 11 consisting of a plurality of numeric keys, special input keys and registration keys to set an operating time of an electronic appliance, a display unit 12 for displaying the remaining operating time of a power plug 2 transmitted from a control means 3 and ON/OFF operating statuses of the electronic appliance on a screen, a signal tone generating unit 13 for outputting a confirming tone through a speaker 14 when a response signal is received from the control means 3, a wireless transmitting unit 15 for transmitting preset operating time information and registration information input by the manipulation of the key unit 11 in a wireless manner, a wireless receiving unit 17 for receiving the response signal (remaining operating time and ON/OFF statuses) from the control means 3 and providing the response signal to a first micro processing unit (MPU) 20, a transmission power control unit 16 for controlling a drive power supplied to the wireless transmitting unit 15, a reception power control unit 18 for controlling a drive power supplied to the wireless receiving unit 17, a power unit 19 for supplying a drive power to the remote controller 1, and the first MPU 20 for transmitting unique registration information and operating time information of the remote controller 1 depending on the manipulation of the key unit 11 to the control means 3 through the wireless transmitting unit 15 and driving the signal tone generating unit 13 to output the confirming tone while displaying a response signal to the transmitted information on the display unit 12, if the response signal is transmitted from the control means 3 and received through the wireless receiving unit 17;

the plug 2 for supplying a power to the electronic appliance; and

the control means 3 comprised of a wireless transmitting unit 31 and a wireless receiving unit 32 for communicating wireless data with the remote controller 1, a memory 35 for storing therein registered code information of the remote controller 1 and preset operating time information transmitted from the remote controller 1, a clock generating unit 36 for generating clock signals at regular periods, a direct current (DC) power unit 38 for converting an alternating current (AC) power input to the plug 2 into a DC power and supplying the DC power as an internal drive power, a second MPU 42 for performing real-time counting using the clock signals generated by the clock generating unit 36 and outputting a control signal to shut off the power when a counted value is identical with the preset operating time, transmitted from the remote controller 1 and stored in the memory 35, a power control unit 40 for controlling a transistor Q1 to be turned on/off in response to the control signal output from the second MPU 42, and the transistor Q1 turned on/off in response to a control signal output from the power control unit 40 to turn off a relay switch 41 connected to a power line at one end of the plug 2, so that the control means 3 controls the electronic appliance to be automatically turned off after the electronic appliance is operated for the preset operating time transmitted from the remote controller 1.

The present invention is characterized in that the control means 3 further comprises a load detecting unit 39 on an output side of the relay switch 41 to detect a load due to the operation of the electronic appliance, and the second MPU 42 recognizes that the electronic appliance is operated only when the load detecting unit 39 detects a load, and counts an actual operating time using the clock signals generated by the clock generating unit 36.

The present invention is characterized in that the control means 3 further comprises a low voltage detecting unit 37 for detecting an abnormal fluctuation in the power input to the plug 2 and providing the detected results to the second MPU 42, and the second MPU 42 is reset after storing a value, obtained by counting actual operating time until a voltage fluctuation signal is input from the low voltage detecting unit 37, in the memory 36, and then continuously counts the remaining operating time on the basis of the operating time counting value stored in the memory 35 after reset.

The present invention is characterized in that the control means 3 transmits the remaining operating time of the power plug 2 and ON/OFF status information of the power to the remote controller 1 in a wireless manner, thus allowing a user to monitor the information through the display unit 12 of the remote controller 1.

Further, the present invention is characterized in that the control means 3 transmits a predetermined alarm signal to the remote controller 1 when the remaining operating time is less than a predetermined time, thus outputting an alarm through the signal tone generating unit 13 of the remote controller 1.

Further, reference numerals 33 and 34, which are not described, represent a transmission power control unit for controlling a drive power supplied to the wireless transmitting unit 31, and a reception power control unit for controlling a drive power supplied to the wireless receiving unit 32, respectively.

In the meantime, the control means 3 is implemented to exchange information with a terminal unit 5, such as a telephone provided in home, so that parents can access the terminal unit 5 from a remote place and then remotely controls the control means 3, thus enabling the operating time of the plug 2 to be controlled.

The operation of the present invention having the above construction is described below.

First, the user inserts the plug 2 of an electronic appliance equipped with the control means 3 into an outlet to allow a drive power to be supplied to the second MPU 42. The second MPU 42 is in a standby mode for a certain period when the drive power is initially supplied. For the certain period, the user registers a unique code of the remote controller 1 in the control means 3.

The registration of the unique code is performed as the user presses a specific registration key provided on the key unit 11 of the remote controller 1. If the user presses the registration key, the first MPU 20 having recognized the pressing of the registration key transmits the unique registration code of the remote controller 1 to the control means 3 through the wireless transmitting unit 15. The second MPU 42 of the control means 3 stores the unique registration code transmitted from the remote controller 1 in the memory 35, compares a signal received by the wireless receiving unit 23 after the unique registration code with the registration code stored in the memory 35, determines whether the received signal and the registration code are identical with each other, and then uses the received signal as a valid signal.

In the meantime, the second MPU 42 having received the unique registration code from the remote controller 1 transmits a response signal to the remote controller 1 again through the wireless transmitting unit 31. When receiving the response signal from the control means 3, the first MPU 20 of the remote controller 1 outputs a message indicating that the unique code of the remote controller 1 is registered in the control means 3 through the display unit 12 while driving the signal tone generating unit 13 to output a predetermined confirming tone through the speaker 14, thus enabling the user to confirm the confirming tone and the message.

As described above, if the user manipulates numeric keys provided on the key unit 11 to set the operating time of the electronic appliance and then presses a specific key after the process for registering the unique code of the remote controller 1 has been completed, the first MPU 20 transmits the information of the preset operating time to the control means 3 through the wireless transmitting unit 15.

The second MPU 42 of the control means 3 stores the preset operating time information received from the remote controller 1 in the memory 35, performs real-time counting using synchronous clock signals generated by the clock generating unit 36, and then outputs a control signal to shut off the power supplied to the electronic appliance to the power control unit 40 when a counted value is identical with the preset operating time stored in the memory 35. The power control unit 40 turns off the relay switch 41 connected to the power line at one end of the plug 2 by turning off the transistor Q1 in response to the control signal output from the second MPU 42, thus shutting off the power supplied to the electronic appliance.

Further, the second MPU 42 of the control means 3 outputs an alarm signal to the remote controller 1 when the counted remaining operating time of the electronic appliance is less than a predetermined time (for example, five minutes). The first MPU 20 of the remote controller 1 drives the signal tone generating unit 13 in response to the received alarm signal to output a predetermined alarm, so that the parents confirm the remaining operating time of the electronic appliance, thus allowing their child to terminate the operation of the electronic appliance.

By the above-described function, a problem can be prevented in that, as the power of the electronic appliance, such as a computer, is unexpectedly turned off, programs of the computer may be damaged. Further, the control means 3 is equipped with the speaker capable of outputting an alarm, so that the child using the electronic appliance personally hears the alarm and turns off the electronic appliance.

Through the above operation, the parents control their child to suitably control the time spent using a computer, a television, a video game machine, etc., thus allowing the child to have a free time while concentrating on studies.

In the meantime, the load detecting unit 39 of the present invention detects the status of a load according to whether the electronic appliance is operated, and transmits the detected information to the second MPU 42. The second MPU 42 counts the actual operating time in real-time using the clock signals generated by the clock generating unit 36 only when the operation of the electronic appliance is detected by the load detecting unit 39. If the operation of the electronic appliance is not detected by the load detecting unit 39, the second MPU 42 does not count the operating time any longer and stops the counting.

Further, if an abnormal fluctuation occurs on the AC power input to the plug 2, the abnormality of the power is detected by the low voltage control unit 37 and the detected information is provided to the second MPU 42. The second MPU 42 recognizes the low voltage state of the input power, stores actual operating time data obtained at the time of recognition in the memory 35, and is then reset. After the reset, the second MPU 42 continuously counts the remaining operating time on the basis of the actual operating time stored in the memory 35 to control the supply of the power to the power plug 2.

The second MPU 42 provided in the control means 3 transmits the remaining operating time information at the time of counting the actual operating time and current ON/OFF status information of the electronic appliance to the remote controller 1, thus enabling the user (parents) to visually confirm both the preset time to turn off the operation of the electronic appliance and the current operating status thereof through the display unit 12 provided on the remote controller 1.

In the meantime, the control means 3 provided in the present invention can be constructed to communicate with the terminal unit 5, such as a telephone placed in the home, in a wireless manner. Through the above construction, the user accesses the terminal unit 5 outside of the home, not in the home, and then remotely controls the control means 3 through the terminal unit 5, thereby setting and changing the operating time of the electronic appliance.

### INDUSTRIAL APPLICABILITY

As described above, the present invention provides a remote-controllable time-based power control apparatus, which includes a remote controller, which is capable of setting the operating time of a power plug and has a display unit for displaying the remaining operating time and ON/OFF statuses, and a control means for turning on the power plug for the preset operating time received from the remote controller while communicating with the remote controller in a wireless manner and turning off the power plug to automatically turn off an electronic appliance when time counted by the control means reaches the preset operating time, thus enabling parents to remotely control the operating times of computers, video game machines, televisions, etc. enjoyed by their children.

1. A remote-controllable time-based power control apparatus, comprising:
a remote controller (1) provided with keys to set an operating time of an electronic appliance to transmit setting information for the operating time to control means (3) connected to a plug (2) in a wireless manner, the remote controller (1) comprising a display unit (12) and a signal tone generating unit (13) for visually and aurally informing a user of power control information transmitted from the control means (3);
the plug (2) for supplying a power to the electronic appliance; and
the control means (3) comprising a wireless transmitting unit (31) and a wireless receiving unit (32) for communicating wireless data with the remote controller (1), a memory (35) for storing therein registered code information of the remote controller (1) and preset operating time information transmitted from the remote controller (1), a clock generating unit (36) for generating clock signals at regular periods, a direct current (DC) power unit (38) for converting an alternating current (AC) power input to the plug (2) into a Direct Current (DC) power and supplying the DC power as an internal drive power, a second MPU (42) for performing real-time counting using the clock signals generated by the clock generating unit (36) and outputting a control signal to shut off the power when a counted value is identical with the preset operating time transmitted from the remote controller (1) and stored in the memory (35), a power control unit (40) for controlling a transistor (Q1) to be turned on/off in response to the control signal output from the second MPU (42), and the transistor (Q1) turned on/off in response to a control signal output from the power control unit (40) to turn off a relay switch (41) connected to a power line at one end of the plug (2), the control means (3) controlling the electronic appliance to be automatically turned off after the electronic appliance is operated for the preset operating time transmitted from the remote controller (1).

2. The remote-controllable time-based power control apparatus according to claim 1, wherein:
the control means (3) further comprises a load detecting unit (39) on an output side of the relay switch (41) to detect a load due to the operation of the electronic appliance; and
the second MPU (42) recognizes that the electronic appliance is operated only when the load detecting unit (39) detects a load, and counts an actual operating time using the clock signals generated by the clock generating unit (36).

3. The remote-controllable time-based power control apparatus according to claim 1, wherein:
the control means (3) further comprises a low voltage detecting unit (37) for detecting an abnormal fluctuation in the power input to the plug (2) and providing the detected results to the second MPU (42); and
the second MPU (42) is reset after storing a value, obtained by counting an actual operating time until a voltage fluctuation signal is input from the low voltage detecting unit (37), in the memory (36), and then continuously counts the remaining operating time on the basis of the operating time counting value stored in the memory (35) after reset.

4. The remote-controllable time-based power control apparatus according to claim 1, wherein the control means (3) transmits the remaining operating time of the power plug (2) and ON/OFF status information of the power to the remote controller (1) in a wireless manner, thus allowing the user to monitor the information through the display unit (12) of the remote controller (1).

5. The remote-controllable time-based power control apparatus according to claim 1, wherein the control means (3) transmits a predetermined alarm signal to the remote controller (1) when the remaining operating time is less than a predetermined time, thus outputting an alarm through the signal tone generating unit (13) of the remote controller (1).
